(19) United States
(12) Patent Application Publication
(10) Pub. No.: US 2024/0403588 A1
(43) Pub. Date: Dec. 5, 2024

(54) ITEM ORGANISATION SYSTEM

(71) Applicant: DIY Resolutions Pty Ltd, Cambellfield (AU)

(72) Inventor: Julius Jeppe, Perth (AU)

(21) Appl. No.: 18/798,641

(22) Filed: Aug. 8, 2024

Related U.S. Application Data
(63) Continuation of application No. PCT/AU2023/050091, filed on Feb. 10, 2023.

(30) Foreign Application Priority Data
Feb. 10, 2022 (AU) 2022900274

(51) Int. Cl. G06K 7/14

(52) U.S. Cl. CPC G06K 7/1417

(57) ABSTRACT

The present invention relates to an item organisation system (100) that includes: one or more storage labels (200), each including a two-dimensional label region (202) containing: a storage attribute code (203) including visible machine-readable indicia (204) encoding data; and a receptacle identifier (210), the receptacle identifier comprising a string of one or more human readable alphanumeric characters, wherein the data encoded by the visible machine-readable indicia includes the receptacle identifier; and a computer program including instructions, which when executed by one or more processors of an electronic device, cause the electronic device to capture an image of the storage attribute code (203) and to decode the data encoded therein to generate decoded data.

### CROSS-REFERENCES TO RELATED APPLICATIONS

This application is a continuation application of International Patent Application No. PCT/AU2023/050091 entitled “ITEM ORGANISATION SYSTEM,” filed on Feb. 10, 2023, which claims priority to Australian Patent Application No. 2022900274, filed on Feb. 10, 2022, each of which are herein incorporated by reference in their entirety for all purposes.

### FIELD

The present invention relates to systems and methods for organising items. In one embodiment, the present invention relates to a system for organising items that are stored in storage receptacles.

### BACKGROUND

There are various approaches to organising items stored in storage receptacles (such as boxes), some of which involve labelling the storage receptacles with a description of the stored items.

Current approaches suffer from the deficiency of limited label space. For receptacles that store a variety of items, it can be simply impractical to list all items in the limited label space. Limited label space also makes it difficult to include a detailed enough description of the stored items that can be used to efficiently retrieve the items from storage.

The present invention aims to provide an alternative system for organising items.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### BRIEF SUMMARY

In accordance with the present invention there is provided an item organisation system including:
one or more storage labels, each including a two-dimensional label region containing:
a storage attribute code including visible machine-readable indicia encoding data; and
a receptacle identifier, the receptacle identifier comprising a string of one or more human readable alphanumeric characters, wherein the data encoded by the visible machine-readable indicia includes the receptacle identifier; and
a computer program including instructions, which when executed by one or more processors of an electronic device, cause the electronic device to capture an image of the storage attribute code and to decode the data encoded therein to generate decoded data.

In another aspect, the present invention provides a non-transitory computer-readable storage medium storing one or more programs, the one or more programs comprising instructions, which when executed by one or more processors of an electronic device, cause the electronic device to:
capture an image of a storage attribute code that includes visible machine-readable indicia encoding data; and
process the image to decode the data and generate decoded data,
wherein the storage attribute code is applied to a storage label with a two-dimensional label region that includes a receptacle identifier, the receptacle identifier including a string of one or more human readable alphanumeric characters, wherein the data encoded by the visible machine-readable indicia includes the receptacle identifier.

The present invention provides an item organisation system that allows for efficient storage and convenient retrieval of items stored in storage receptacles. In particular, the present invention provides storage labels that include a machine-readable element (that can take the form of a QR code or similar) and a human-readable element. The machine-readable element encodes the human-readable element (typically along with other data). This allows the human-readable element to uniquely identify a storage receptacle to a user, for example to allow the user to select the storage receptacle from amongst other receptacles.

Encoding the human-readable element (or a mapping to the human-readable element) in the machine-readable elements also allows the human-readable element to uniquely identify the storage receptacle within the item organisation system. This allows the human-readable element to serve as an entry point (such as in a Web API) to services that the item organisation system provides.

Preferably, the instructions further cause the electronic device to:
process the decoded data to obtain a storage image associated with a receptacle identified by the receptacle identifier; and
display the storage image on the electronic device.

Processing the decoded data may include:
submitting the decoded data as a search query to an item storage database associated with the item organisation system; and
receiving the storage image at the electronic device as a search result of the search query.

Typically, the storage image depicts items stored in the receptacle.

In one embodiment, the storage image is captured by a user of the item organisation system and stored in a user account maintained for the user in the item organisation system.

The instructions further cause the electronic device to render an augmented reality display on the electronic device, the augmented reality display including the storage image displayed on an incoming video feed capturing the storage attribute code.

Optionally, the instructions further cause the electronic device to:
receive a storage search query at the electronic device;
process the storage search query to generate a search query result, the search query result including the or each receptacle identifier that identifies a receptacle storing an item referenced in the storage search query; and
display the search query result on the electronic device.

The instructions may further cause the electronic device to:
retrieve from a data storage one or more storage images stored in the data storage for a user of the item organisation system;
display the one or more storage images on the electronic device;
receive at the electronic device a selection of at least one of the displayed storage images;
process the or each selected storage image to obtain a receptacle identifier list that includes the respective receptacle identifier associated with each selected storage image; and
display the receptacle identifier list on the electronic device.

Optionally, the one or more storage attribute codes are digitally signed by an administrator of the item organisation system using a private encryption key.

In other embodiments, the receptacle identifier is disposed amongst the visible machine-readable indicia.

According to a further aspect of the present invention, there is provided a storage label, including a two-dimensional label region containing:
a storage attribute code including visible machine-readable indicia encoding data; and
a receptacle identifier, the receptacle identifier including a string of one or more human-readable alphanumeric characters, wherein the data encoded by the visible machine-readable indicia includes the receptacle identifier, the storage label being operative for use in an item organisation system according to the first aspect of the present invention.

### BRIEF DESCRIPTION OF THE DRAWINGS

One or more embodiments of the present invention will be described by reference to the following drawings, in which:

FIG. 1 is a block diagram illustrating a network environment in which aspects of the present invention may be implemented.

FIG. 2A illustrates a first embodiment of a storage label in accordance with an embodiment of the present invention.

FIG. 2B illustrates a second embodiment of a storage label in accordance with a second embodiment of the present invention.

FIG. 3 illustrates storage labels affixed to the exterior of storage receptacles.

FIGS. 4 and 5 are schematic illustrations of user interfaces generated by an item organisation system in accordance with an embodiment of the present invention.

FIGS. 6 to 9 are flowcharts illustrating various computing routines performed by an item organisation system in accordance with an embodiment of the present invention.

FIGS. 10 to 13 are schematic illustrations of user interfaces generated by an item organisation system in accordance with an embodiment of the present invention.

FIG. 14 is a flowchart illustrating a synchronisation routine performed by an item organisation system in accordance with the present invention.

FIG. 15 is a block diagram illustrating a computer system, which may be used to implement various embodiments of the present invention.

While the invention is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention.

### DETAILED DESCRIPTION

In the following description, for the purposes of explanation, numerous specific details are set forth to provide a thorough understanding of the present invention. It will be apparent, however, that the present invention may be practiced without these specific details. In some instances, well-known structures and devices are shown in block diagram form to avoid unnecessary obscuring.

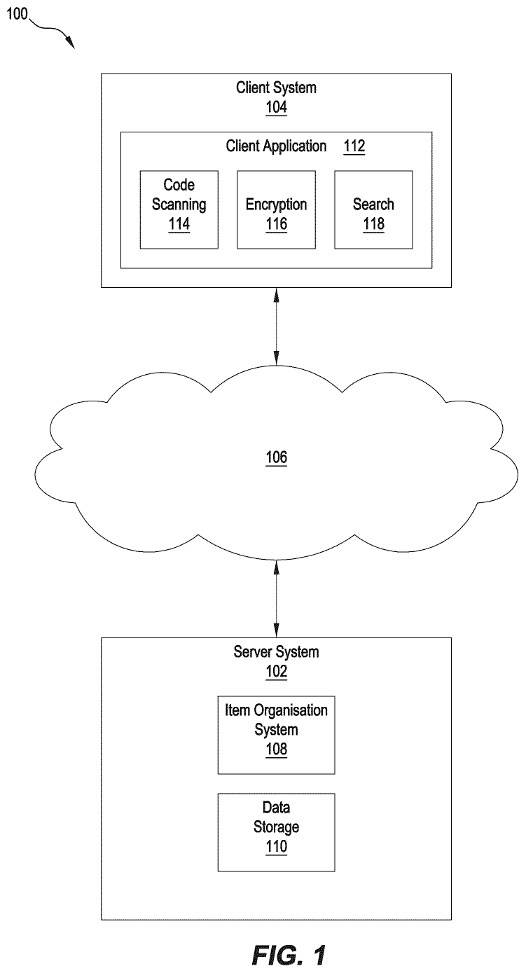

FIG. 1 illustrates a computing environment 100 in which aspects of the present invention are implemented. The environment 100 is a networked environment comprising a server system 102 in communication with a client system 104 over one or more communication networks 106. Aspects of the computer processing described below are performed by a server application 108 (hereinafter referred to as an “item organisation system”) executing on the server system 102 and a client application 112 executing on the client system 104.

Server system 102 further includes a data storage 110 on which data managed by the item organisation system 108 is stored. Data storage 110 is typically a storage medium such as a hard drive (or collection of hard drives). A database management system (not shown) executing on server system 102 implements a database on data storage 110 for storing and retrieving data managed by the item organisation system 108. As described in further detail below, a user can establish an account with the item organisation system 108 and store data pertaining to the user's personal items and the storage receptacles in which those items are stored. The totality of user accounts established with the item organisation system 108 are stored in data storage 110.

Server system 102 has been illustrated as a single system. Server system 102 can, however, be a scalable server system comprising multiple nodes which can be commissioned/decommissioned based on processing demands. Typically, server systems are server computers that provide greater resources (e.g. processing, memory, network bandwidth) in comparison to client systems.

In the illustrated embodiment, data storage 110 is illustrated as part of the server system 102. However, the data storage 110 could be a separate system in operative networked communication with the server system 102. For example, the data storage could be a networked-attached storage device, an entirely separate storage system accessed via a database management system, or any other appropriate data storage mechanism.

As described in further detail below, the item organisation system 108 performs various operations in response to commands received from (and initiated at) client application 112. As such, when executed by the server system 102, the item organisation system 108 configures the server system 102 to provide server-side functionality to client application 112. To provide this functionality, the item organisation system 108 comprises one or more suitable application programs, libraries, or other software infrastructure.

Where the client application 112 is a web browser, the item organisation system 108 will typically be, or interact with, a web server such as a server implemented with the node.js runtime environment. Where the client application 112 is a dedicated application provided specifically to interact with the item organisation system 108, the item organisation system 108 will typically be, or interact with, an application server. Server system 102 may be provided with both web server and application server applications to enable it to serve both web browser and dedicated client applications.

The server system 102 and client system 104 communicate data between each other either directly or indirectly through one or more communications networks 106.

Communications network 106 may comprise a local area network (LAN), a public network (such as the Internet), or a combination of networks.

Environment 100 is a networked environment. In alternative embodiments, however, the item organisation system 108 may be locally installed on a computer system (e.g. client system 104) and configured to perform operations for that client system alone. In this case a server system is not required.

While only one client system 104 is depicted in environment 100, a typical environment would typically include many more client systems served by the server system 102.

While client system 104 can be any type of computer system, including a desktop computer or laptop computer, it will more commonly be a smartphone or a tablet device. When executed by the client system 104, the client application configures the client system 104 to provide client-side item-organisation functionality and interact with sever system 102 (or, more specifically, the item organisation system 108 running thereon).

The client application 112 may be a general web browser application (such as Chrome, Edge, Safari or the like) which accesses the item organisation system 108 via an appropriate uniform resource locator (URL) and communicates with the item organisation system 108 via general world-wide-web protocols (e.g. http, https, ftp) and application programming interfaces (APIs) (e.g. REST APIs). Alternatively, the client application 112 may be a specific application programmed to communicate with the item organisation system 108 using defined API calls.

A given client system 104 may have more than one client application 112 installed thereon, for example both a general web browser application and a dedicated programmatic client application.

The client application 112 includes several software modules that together provide item-organisation functionality to the user. In this regard, client application 112 includes a code scanning module 114, an encryption module 116, and a search module 118.

Code scanning module 114 includes software library routines that control the client system's 112 in-built camera to capture an image of an optical code. Typically, the present disclosure utilises quick response (QR) codes, however those skilled in the art will appreciate that other types of optical codes can be used, such as barcodes. The code scanning module 114 also includes software library routines that decode (and thereby extract) data that is encoded in the image of the optical code. As described in further detail below, the item organisation system of the present disclosure utilises optical codes, in combination with the client application 112, to allow users to create, search and manage data pertaining to catalogues of items stored within storage receptacles (such as boxes, shelving and the like).

The encryption module 116 includes software library routines that manage the encryption and decryption of data that is encoded in the optical codes. The encryption module 116 also manages encryption and decryption of data stored on the client application 112 and/or in data storage 110. In addition, as described in further detail below, the encryption module 116 utilises a digital signature algorithm to authenticate the optical codes that are used in the item organisation system according to the present disclosure.

The search module 118 provides a search front-end to the user. As described in further detail below, the search module 118 provides both a text and an image search front-end to the user.

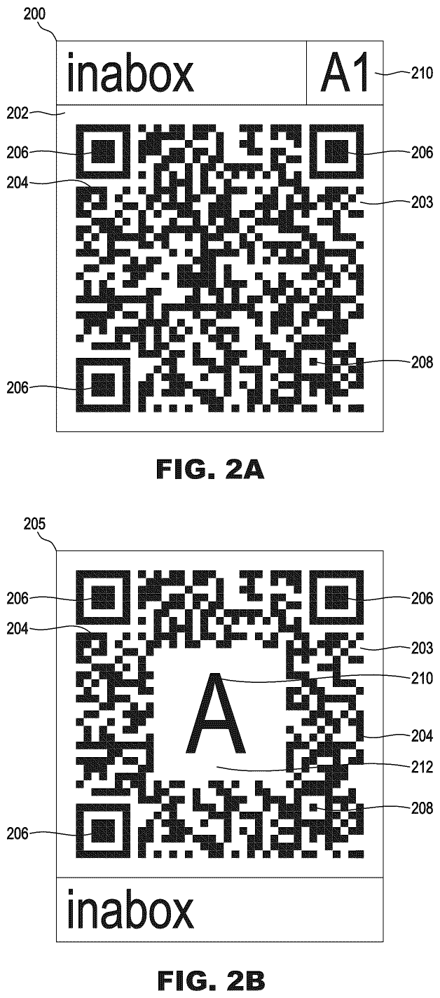

The item organisation system of the present disclosure utilises storage labels to which an optical code (hereinafter referred to as a “storage attribute code”) is applied. An embodiment of a storage label 200 is illustrated in FIG. 2A. The exemplified storage label 200 is composed of a two-dimensional area that defines a label region 202. A storage attribute code 203, that includes visible machine-readable indicia 204 is applied to the storage label 200 such as by printing (in the case of a physical label) or through displaying the storage label on an electronic device display (such as a smartphone screen).

In the illustrated embodiment, machine-readable indicia 204 comprises a plurality of discrete squares of varying sizes and relative locations, disbursed throughout the perimeter of the storage attribute code 203. In the illustrated embodiment, position markers 206 are located in three of the corners of the storage attribute code 203. Storage attribute code 203 also includes an alignment marker 208. Data is encoded in the storage attribute code 203 through the remaining squares and other visible indicia.

As those skilled in the art will appreciate, to decode the data encoded in an optical code, an image sensor (such as the sensor found in a smartphone camera) is used to capture an image of the optical code. The smart phone then executes programming to convert the squares in the captured image to binary numbers, thereby extracting the encoded data. Typically, the programming also validates the extracted data using an error-correction key incorporated in the code along with an error-correction algorithm.

Storage label 200 also includes human-readable indicia in the form of an alphanumeric character string 210. In the illustrated embodiment, the character string 210 is located in the top right-hand corner of the storage label 200, adjacent to the storage attribute code 203. As described in further detail below, a character string functions as a receptacle identifier in the item organisation system of the present disclosure. In the illustrated embodiment, character string 210 is the two-character string “A1”. However, those skilled in the art will appreciate that alphanumeric strings (or the graphic characters of ideographic languages) of varying lengths could also be used.

An alternative embodiment of a storage label 205 is illustrated in FIG. 2B. In this embodiment, the alphanumeric character string 210 is located in the centre of the storage attribute code 203 and is surrounded by an empty peripheral region 212. The use of a peripheral region 212 improves the readability of the character string 210 by providing visual separation from the machine-readable portion of the storage attribute code 203.

It is not essential to locate the character string 210 in the centre of the storage attribute code 203, however it is preferred, as it provides the code with higher redundancy and increased density.

According to the present disclosure, the item organisation system comprises multiple storage labels, each with a unique receptacle identifier, that are typically packaged and distributed as a set. In this regard, sets of storage labels of a desired size and string length can be constructed using a combination of character and numeric string elements. For example, a set of 10 storage labels can be constructed with the character strings: A1-A10. Similarly, a set of 20 storage labels can be constructed with the character strings: A1-A10 and B1-B10.

As discussed in further detail below, the administrator of the item organisation system digitally signs the storage attribute codes with a private encryption key prior to distributing the codes for use in the item organisation system.

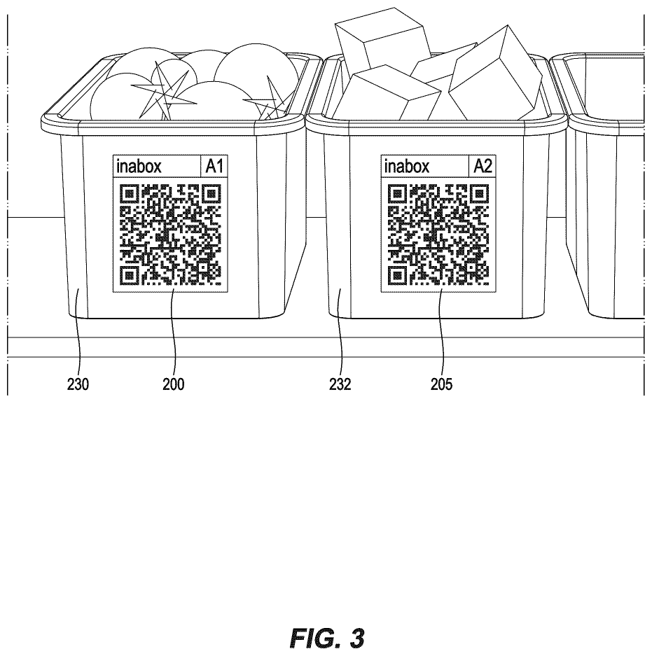

Turning to FIG. 3, after the storage labels 200 are digital signed by the administrator, the user of the item organisation system 108 can suitably affix the storage labels to the exterior of a storage receptacle. FIG. 3 shows storage labels 200 and 205 respectively affixed to the exterior of storage receptacles 230 and 232. It will be noted that the receptacle identifiers of each storage label 200 and 205 (namely A1 and A2) are clearly visible. Those skilled in the art will appreciate that several copies of the same storage label could be affixed to a single receptacle. This allows the receptacle to be placed on a shelf in a variety of orientations with at least one of the storage labels being visible to the user.

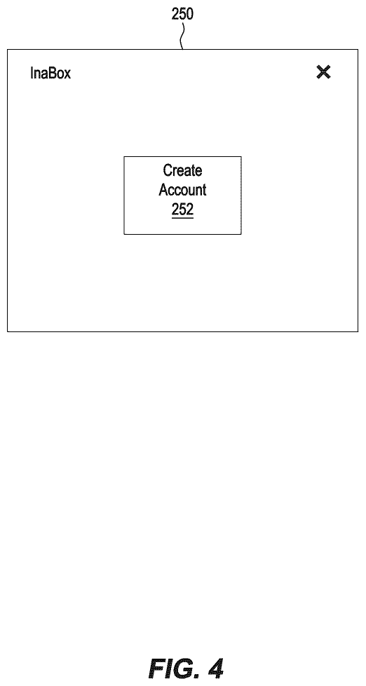

FIG. 4 illustrates an exemplary user interface 250 that client application 112 renders on client system 104. User interface 250 allows a user of the client system 104 to establish an account with the item organisation system 100. To this end, user interface 250 includes a push button 252, which, once activated by the user, causes the client application 112 to display a webform (or similar) on the client system (not shown). The user enters suitable data into the webform's fields (username, password, email address etc) that the client application 112 communicates to the server system 102 to establish the account.

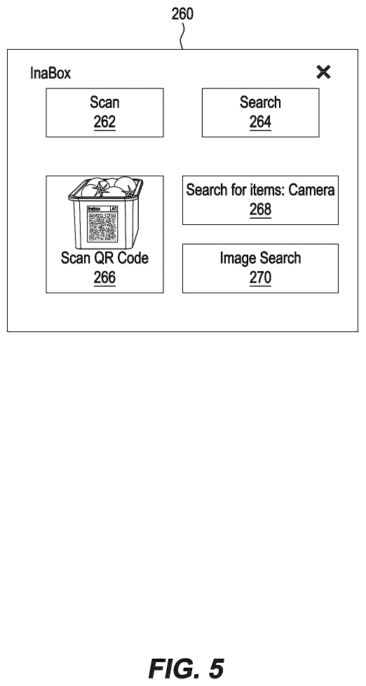

FIG. 5 shows an exemplary user interface 260 that client application 112 renders on client system 104 after the user of client system 104 successfully creates an account with the item organisation system 100. User interface 260 includes user interface objects 262 and 264, which in the illustrated embodiment are buttons. Once activated by the user, buttons 262 and 264 respectively cause the client application 112 to launch code scanning and searching functionality.

To scan a storage attribute code, the user operates the smartphone camera so that the code is located in a viewer window 266 provided in user interface 260. Once the code is located in viewer window 266, the user pushes button 262, that causes the camera to capture an image of the code. The client application 112, upon detecting the user pushing button 262, also launches an initial code scanning routine from code scanning module 114.

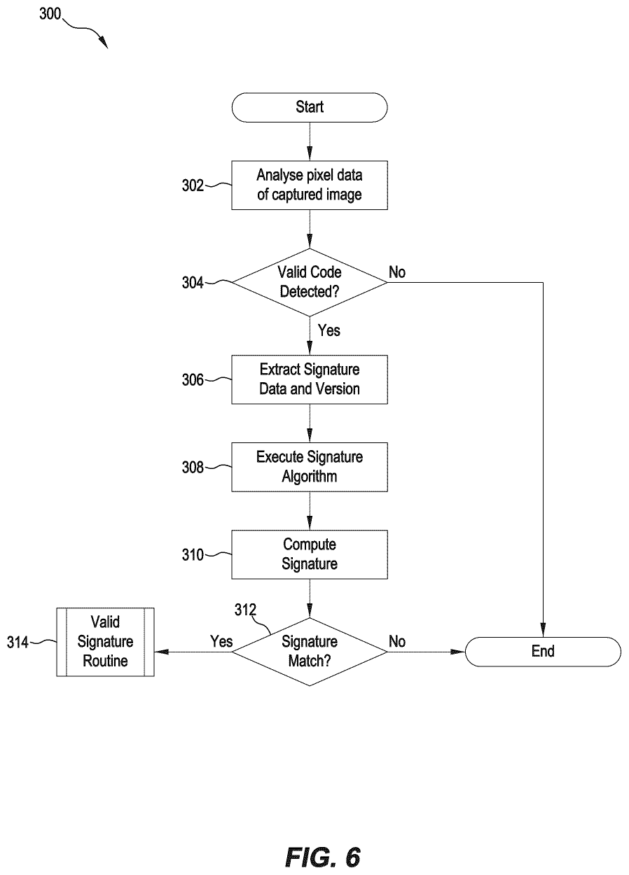

The processing performed by the initial code scanning routine 300 is illustrated by reference to FIG. 6. Routine 300 commences at step 302, at which the client device 104 executes functionality from the code scanning module 114 that analyses the pixel data of the captured image and extracts code data therefrom.

At step 304, the code scanning module determines whether the extracted code data is consistent with the presence of a valid code in the captured image. The routine terminates in the event that the code scanning module 114 does not detect a valid code in the captured image.

If the code scanning module 114 detects a valid code, the routine 300 proceeds to step 306, at which the code scanning module 114 recovers digital signature data and a digital signature version from the code data. The digital signature version includes an address from which an authenticated public key can be downloaded that corresponds to the private key that the administrator used to digitally sign the code.

At step 308, the code scanning module 114 executes a signature algorithm that attempts to decrypt the digital signature data with the authenticated public key. Successfully decrypting the digital signature data with the public key is a clear indication that the administrator initially signed the code using the corresponding private key, and that the code will thus function correctly in the item organisation system 108.

At step 310, the code scanning module 114, using data from the digital signature version, computes a cryptographic hash (or other suitable cryptographic function) of the code data.

At step 312, the code scanning module 114 compares the computed cryptographic hash with a cryptographic hash that forms part of the digital signature data.

The routine terminates in the event that the computed cryptographic hash does not match the digital signature hash.

In the event that the computed cryptographic hash matches the digital signature hash (step 312), the code scanning module launches a valid signature routine 314.

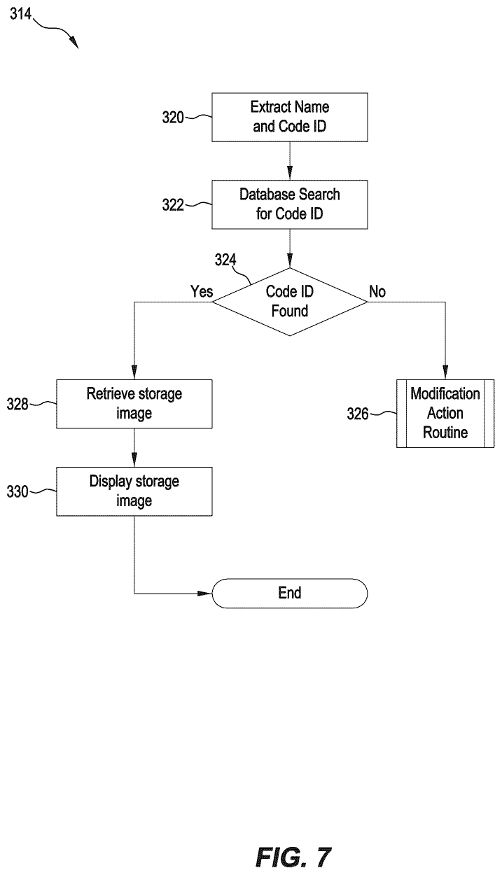

The computing operations performed in the valid signature routine 314 are illustrated by reference to FIG. 7. The routine commences at step 320, at which the code scanning module 114 extracts the Name (i.e. the receptacle identifier) and Code ID of the code from the code data.

At step 322, the code scanning module 114 executes functionality to perform a database search to determine (step 324) whether the Code ID is present in the client system's 104 local storage, or in the server data storage 110.

The absence of the Code ID from local and remote storage indicates that the user has not yet entered details of the code in the item organisation system 108. In this event, the code scanning module 114 executes a modification action routine 326.

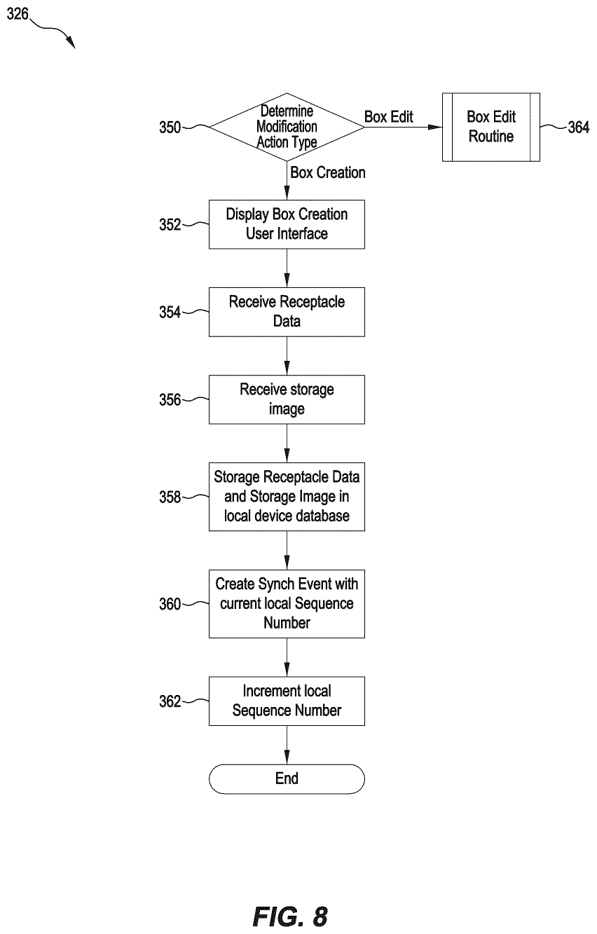

The computing operations performed in the modification action routine are illustrated by reference to FIG. 8. The routine commences at step 350, at which the code scanning module 118 determines the type of modification action that is required. In the case of a “box creation” modification action, the routine proceeds to step 352, at which the code scanning module displays a box creation user interface. The box creation user interface includes a webform (or similar) that allows the user to enter details of the storage receptacle to which the code is affixed. The details that the user enters are stored in the item organisation system 100 in association with the Code ID and receptacle identifier.

More specifically, the item-organisation system 108 is configured to receive (step 354) receptacle data including:
the receptacle identifier depicted in the storage label and included in the storage attribute code's encoded data;
receptacle type;
receptacle location;
location ID;
receptacle capacity; and
a list or description of the items contained in the receptacle.

At step 356, the code scanning module 118 displays a user interface on the client system 104 that prompts the user to upload a photograph (or other image) of the items that are stored in the receptacle. The code scanning module 118 receives the storage image that the user uploads.

At step 358, the code scanning module 118 stores the received receptacle data and storage image in the local storage of the client system 104.

At step 360, the code scanning module 118 invokes a device synchronisation routine (described in further detail below) by creating a Synchronisation Event on the client system 104 using the current value of a maintained variable (namely a local sequence number).

At step 362, the code scanning module 118 increments the local sequence number.

Returning to step 350, in the event that a “box edit” modification action is required, the code scanning module performs a box edit routine 364.

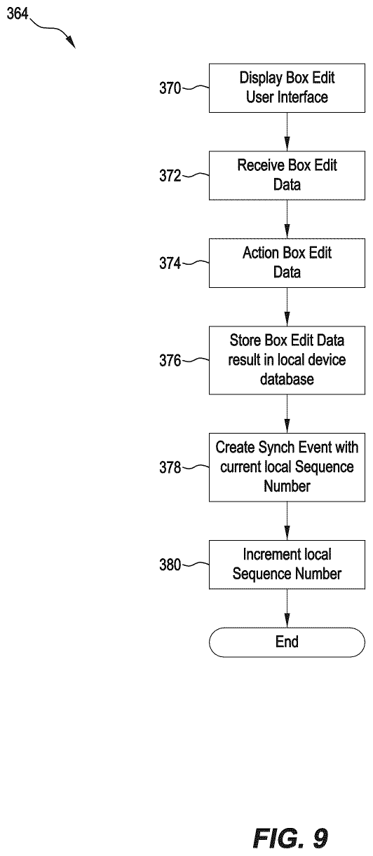

The computing operations performed in the box edit routine are illustrated by reference to FIG. 9. The routine commences at step 370, at which the code scanning module displays a box edit user interface. The box edit user interface includes a webform (or similar) that allows the user to edit (step 372) previously entered receptacle data. The webform also provides the user with functionality to:
delete a receptacle;
create a new storage attribute code;
associate or disassociate the receptacle with the storage attribute code;
delete a storage attribute code;
create a location; and
delete a location.

At step 374, the code scanning module 118 actions the received box edit data by appropriately updating the receptacle data.

At step 376, the code scanning module 118 stores the updated receptacle data in the local storage of the client system 104.

At step 378, the code scanning module 118 creates a Synchronisation Event on the client system 104 using the current value of the local sequence number.

At step 380, the code scanning module 118 increments the local sequence number.

Returning to FIG. 7, step 324, the presence of the Code ID in local or remote storage indicates that the user has previously entered receptacle data into the item-organisation system in association with that particular storage attribute code.

The routine proceeds to step 328, at which the code scanning module 118 searches the local storage or remote storage (using the Code ID) and retrieves the stored storage image.

At step 330, the code scanning module executes functionality to display the storage image on the client system 104.

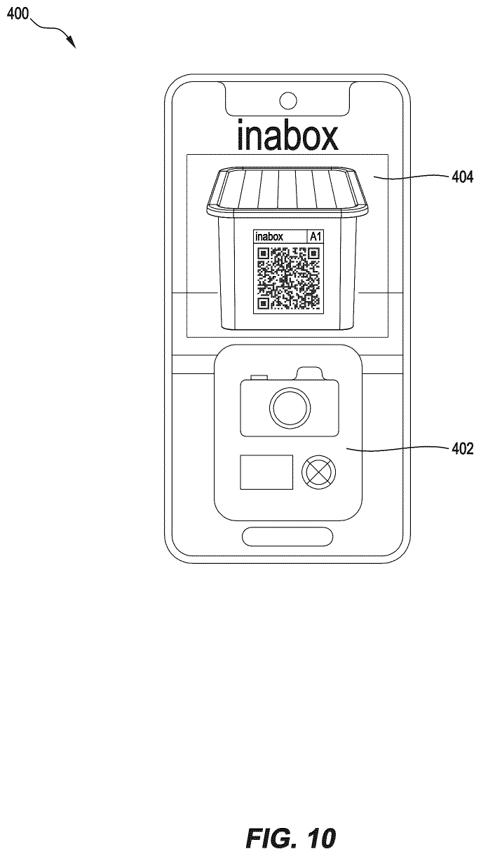

FIG. 10 illustrates an exemplary user interface 400 generated by the code scanning module 118 to display a storage image 402 on the client system. User interface 400 is an augmented reality interface in which the storage image 402 is overlaid on an incoming video feed 404 from the client system's camera. The augmented reality interface 400 provides the user with an ability to “see inside” a storage receptacle without opening the receptacle.

Returning to FIG. 5, the depicted user interface 260, provides user interface objects for both text 268 and image 270 searching.

Text object 268 is configured to receive text search queries from the user. While search queries can be directed to any receptacle data stored in the item organisation system 108, search queries for specific items stored in a receptacle are of particular utility. In this regard, user interface 260 depicts as an example, the user entering ‘camera’ as a search query into the text box 268.

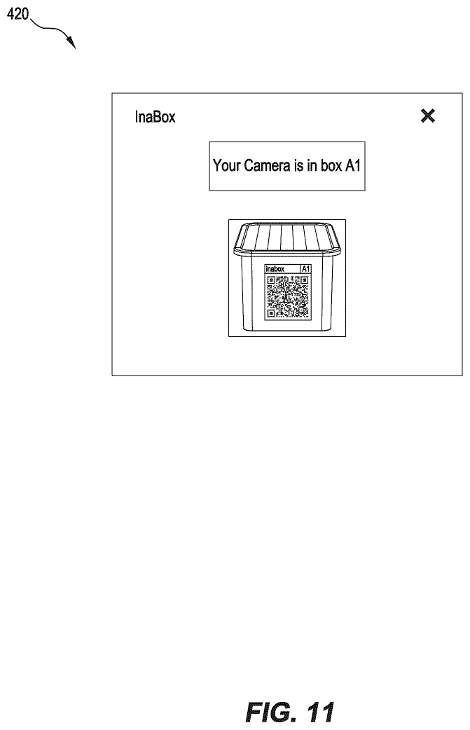

The search module 118, executes the search query by searching local and remote data for records having a camera listed as an item that is stored in a receptacle. FIG. 11 illustrates an exemplary user interface 420 displaying the search results returned from executing the ‘camera’ search query. It will be noted that the search results include details of the human-readable receptacle identifier (in this case ‘A1’). Having this information, the user is readily able to locate the correct receptacle simply by reading the receptacle identifier component of the storage label.

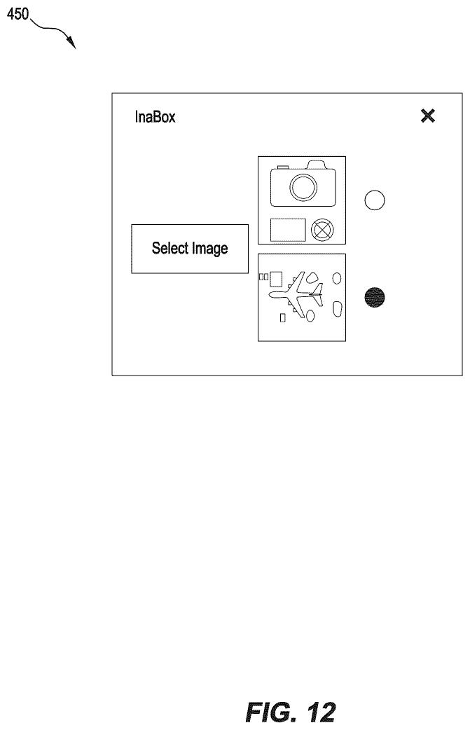

Image user interface object 270 is a button that, once activated by a user, causes the search module 118 to display a user interface that includes a selection, or the entirety of storage images stored in the item-organisation system. An exemplary user interface 450 is shown in FIG. 12. The storage images included in user interface 450 are user selectable. Once the user selects an image, the search module searches local and remote data for the record in which the storage image is stored.

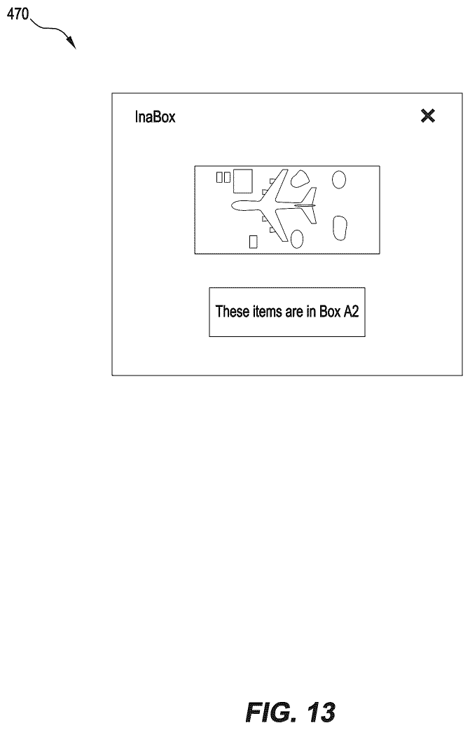

FIG. 13 illustrates an exemplary user interface 470 that displays the results of an image search performed in respect of a selected storage image. Again, it will be noted that the displayed search results include details of the human-readable receptacle identifier in which the items depicted in the storage image are stored.

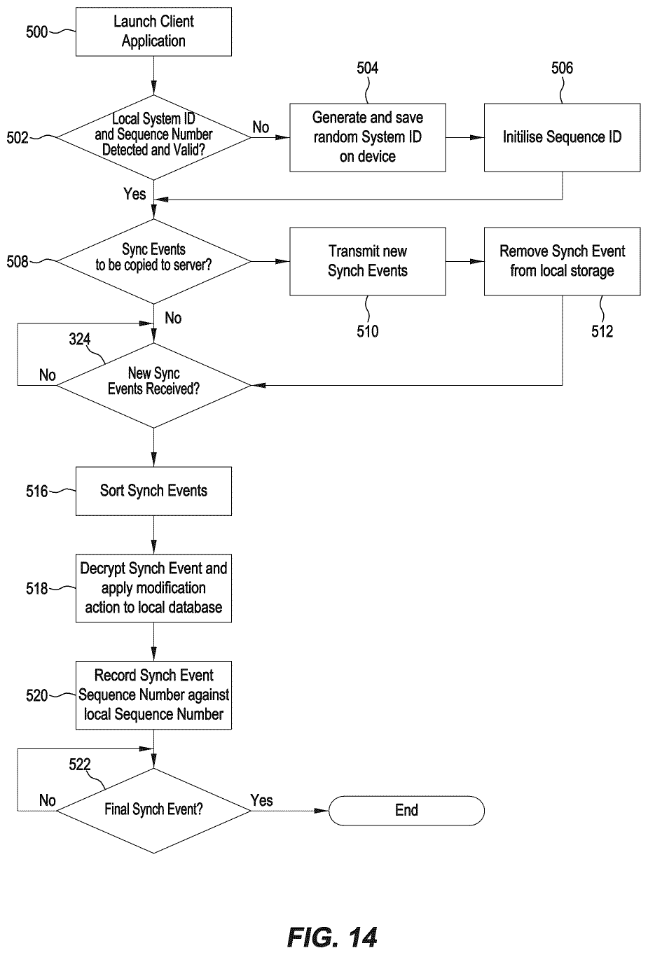

FIG. 14 is a flowchart illustrating a device synchronisation routine performed by the server system 102 to synchronise data across multiple client systems. Manipulation of receptacle data in a client application (for example client application 112 executing on client system 104), either by a user or by a background process, causes the client application 112 to generate a Modification Action. Once generated, the client application 112 encodes the Modification into a Synchronisation Event.

As noted above, a Synchronisation Event is uniquely identified via a:
SystemID (that the client application 112 generates when it first executes on the client system 104); and
SequenceNumber.

The client application 112 initialises the SequenceNumber to 0 and increments the SequenceNumber as each new local Synchronisation Event is generated.

At step 500, a user launches the client application on the client system 104.

At step 502, the client application 112 executes functionality to determine whether there is a generated SystemID stored on the client device 112.

If there is no SystemID stored, the client application 112 (step 504) generates a SystemID and assigns it a random value (for example: aea50090-6313-4c2d-9795-ac7156e7008e). The client application then (step 506) generates and initialises a SequenceID.

At step 508, the client application 112 executes functionality to determine whether there are Synchronisation Events stored on the client device 104 that have not been communicated to the server system 102.

If there are such Synchronisation Events, the client application 112 transmits the Synchronisation Events to the server system 102 (step 510). Along with the new Synchronisation Events, the client application 112 transmits to the server system 102, a list of SystemID/SequenceNumber pairs that that client application has previously received from the server system 102. As described in further detail below, these SystemID/SequenceNumber pairs relate to Synchronisation Events generated by other client devices in the computing environment 100.

At step 512, the client application 112 removes the Synchronisation Event from its local storage.

At step 514, the client application 112 executes functionality to determine whether it has received new Synchronisation Events from the server system 102. As described in further detail below, server system 102 transmits Synchronisation Events that are generated on a first client system to other client systems present in the computing environment 100.

If the client application 112 receives new Synchronisation Events from the server system 102, the client application 112 sorts the received Synchronisation Events using a timestamp included in each Synchronisation Event (step 516).

At step 518, the client application 112 executes functionality to decrypt the first Synchronisation Event and apply the relevant Modification Action to the local client system's 104 local storage.

At step 520, the client application 112 executes functionality to record the SequenceNumber of the first Synchronisation Event against the current SequenceNumber value stored in the client application 112.

At step 522, the client application 112 executes functionality to determine whether the current Synchronisation Event is the final Synchronisation Event requiring processing. The routine terminates after the client application 112 processes the final Synchronisation Event.

The following is an example of the data synchronisation routine described above.

The client application 112 displays user interface 250 to prompt the user to create an account with the item organisation system 108. As an aspect of creating the new account, the user (using interface objects 262 and 266) scans a storage attribute code (for example code: f777fc4f-2f52-4ec6-8506-1b9f01da0bac and receptacle identifier “Z4”), creates a new box (for example “Box one”) and enters a description of the box's content and the box's location into the user interface (for example “cups” and “kitchen”).

In response to receiving the machine-readable indicia from the storage attribute code, the client application 112 generates the following Synchronisation Events:
A LocationCreate event with:
   SystemID: aea50090-6313-4c2d-9795-ac7156e7008e;
   SequenceNumber: 0;
   Timestamp: current UTC date/time;
   LocationID: 6a1c7ca4-5cfd-4a1d-b54c-f2bb4cafd8b4; and
   Location Label: Kitchen.
A Box Create event with:
   SystemID aea50090-6313-4c2d-9795-ac7156e7008e;
   SequenceNumber: 1;
   Timestamp: current UTC date/time;
   BoxID: e9252db-30e7-4181-a7ff-49f647cb5eed;
   LocationID: 6a1c7ca4-5cfd-4a1d-b54c-f2bb4cafd8b4;
   Box Name: “Box one”;
   Code ID: f777fc4f-2f52-4ec6-8506-1b9f01da0bac; and
   Receptacle Identifier: “Z4”.
A Tag Create event with:
   SystemID: aea50090-6313-4c2d-9795-ac7156e7008e;
   SequenceNumber: 2;
   Timestamp: current UTC date/time;
   TagID: ccd97266-837a-4aae-85ec-51d1447cd85a; and
   Tag Name: “cups”.
A Tag Box event with:
   SystemID: aea50090-6313-4c2d-9795-ac7156e7008e;
   SequenceNumber: 3;
   Timestamp: current UTC date/time;
   TagID: ccd97266-837a-4aae-85ec-51d1447cd85a; and
   BoxID: of 1e9252db-30e7-4181-a7ff-49f647cb5eed.

In the foregoing example, the client application 112 determines that SequenceNumbers 0-3 have not been transmitted to server system 102, and the client application 112 thus transmits the Synchronisation Events to the server system 102. Client application 112 has not yet received any Synchronisation Events from the server system 102 and therefore does not include any additional data in its communication to the server system 102.

Upon receipt of the communication, the server system 102 records the Synchronisation Events in data storage 110. The server system 102 records the Synchronisation Events in view of the fact that they are new events from the particular client system 102 (as identified by the SystemID).

The user then installs a second client application on a second client system. Upon start up, the second client application similarly determines that there is not a SystemID stored on the second client system. In response, the second client application generates a SystemID (for example: 05618a42-790f-4233-86fa-142f1a62239a)

Upon the user logging into the item organisation system account, the second client application performs a data synchronisation with the server system 102. The second client system has not received any Synchronisation Events from the server system, nor has it generated any Synchronisation Events itself. Accordingly, the second client application does not include additional data in its request communication with the server system 102.

Upon receipt of the communication, the item organisation system 108 interrogates data storage 110 for all events matching the request, and transmits the following events:
SystemID: aea50090-6313-4c2d-9795-ac7156e7008e, SequenceNumber: 0 (Location Create);
SystemID: aea50090-6313-4c2d-9795-ac7156e7008e, SequenceNumber: 1 (Box Create);
SystemID: aea50090-6313-4c2d-9795-ac7156e7008e, SequenceNumber: 2 (Tag Create);
SystemID: aea50090-6313-4c2d-9795-ac7156e7008e; SequenceNumber: 3 (Tag Box).

Prior to transmission, the item organisation system 108 re-orders the Synchronisation Events using the TimeStamps.

Upon receiving the Synchronisation Events, the second client application applies the following processing to the Synchronisation Events:
SystemID aea50090-6313-4c2d-9795-ac7156e7008e, SequenceNumber 0 the second client application has no record of this Synchronisation Event and so plays it back, creating the location in the local database with the details above;
The second client application records that it has seen SequenceNumber 0 for device aea50090-6313-4c2d-9795-ac7156e7008e;
SystemID aea50090-6313-4c2d-9795-ac7156e7008e, SequenceNumber 1, the second client application has no record of this Synchronisation Event and so plays it back, creating the box in the local database with the details above;
The second client application records that it has seen SequenceNumber 1 for device aea50090-6313-4c2d-9795-ac7156e7008e;
SystemID aea50090-6313-4c2d-9795-ac7156e7008e, SequenceNumber 2, the second client application has no record of this Synchronisation Event and so plays it back, creating the tag in the local database with the details above;
The second client application records that it has seen SequenceNumber 2 for device aea50090-6313-4c2d-9795-ac7156e7008e;
SystemID aea50090-6313-4c2d-9795-ac7156e7008e, SequenceNumber 3 (the Tag Create above)—the second client application has no record of this Synchronisation Event and so plays it back, linking the specified tag and box in the local database with the details above;
The second client application records that it's seen SequenceNumber 3 for device aea50090-6313-4c2d-9795-ac7156e7008e.

After processing the received Synchronisation events, the first and second client applications have identical data.

If the second client application creates its own Synchronisation Events, they are created with its allocated SystemID 05618a42-790f-4233-86fa-142f1a62239a, but with its locally-maintained SequenceNumber, starting at 0.

When the second client application next communicates a synchronisation request with the server system 101, the synchronisation request includes data indicating that it has seen SequenceNumbers 0-3 for SystemID aea50090-6313-4c2d-9795-ac7156e7008e. This is to ensure that the item organisation system 108 does not include these messages in the communication to the second client application.

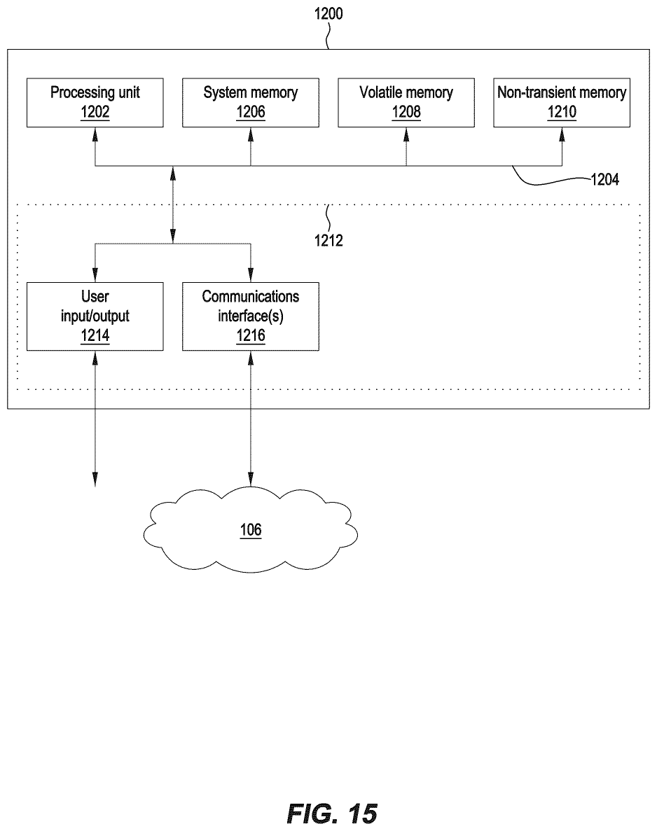

FIG. 15 provides a block diagram of a computer processing system 1200 configurable to implement embodiments and/or features described herein. System 1200 is a general purpose computer processing system. It will be appreciated that FIG. 15 does not illustrate all functional or physical components of a computer processing system. For example, no power supply or power supply interface has been depicted, however system 1200 will either carry a power supply or be configured for connection to a power supply (or both). It will also be appreciated that the particular type of computer processing system will determine the appropriate hardware and architecture, and alternative computer processing systems suitable for implementing features of the present disclosure may have alternative components to those depicted.

Computer processing system 1200 includes at least one processing unit 1202. The processing unit 1202 may be a single computer processing device (e.g. a central processing unit, graphics processing unit, or other computational device), or may include a plurality of computer processing devices. In some instances all processing will be performed by processing unit 1202, however in other instances processing may also be performed by remote processing devices accessible and useable (either in a shared or dedicated manner) by the system 1200.

Through a communications bus 1204 the processing unit 1202 is in data communication with a one or more machine readable storage (memory) devices which store instructions and/or data for controlling operation of the processing system 1200. In this example system 1200 includes a system memory 1206 (e.g. a BIOS), volatile memory 1208 (e.g. random access memory such as one or more DRAM modules), and non-volatile memory 1210 (e.g. one or more hard disk or solid state drives).

System 1200 also includes one or more interfaces, indicated generally by 1212, via which system 1200 interfaces with various devices and/or networks. Generally speaking, other devices may be integral with system 1200, or may be separate. Where a device is separate from system 1200, connection between the device and system 1200 may be via wired or wireless hardware and communication protocols, and may be a direct or an indirect (e.g. networked) connection.

Wired connection with other devices/networks may be by any appropriate standard or proprietary hardware and connectivity protocols. For example, system 1200 may be configured for wired connection with other devices/communications networks by one or more of: USB; Fire Wire; eSATA; Thunderbolt; Ethernet; OS/2; Parallel; Serial; HDMI; DVI; VGA; SCSI. Other wired connections are possible.

Wireless connection with other devices/networks may similarly be by any appropriate standard or proprietary hardware and communications protocols. For example, system 1200 may be configured for wireless connection with other devices/communications networks using one or more of: infrared; Bluetooth; Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Generally speaking, and depending on the particular system in question, devices to which system 1200 connects—whether by wired or wireless means—include one or more input devices to allow data to be input into/received by system 1200 for processing by the processing unit 1202, and one or more output device to allow data to be output by system 1200. Example devices are described below, however it will be appreciated that not all computer processing systems will include all mentioned devices, and that additional and alternative devices to those mentioned may well be used.

For example, system 1200 may include or connect to one or more input devices by which information/data is input into (received by) system 1200. Such input devices may include keyboards, mice, trackpads, microphones, accelerometers, proximity sensors, GPS devices and the like. System 1200 may also include or connect to one or more output devices controlled by system 1200 to output information. Such output devices may include devices such as a CRT displays, LCD displays, LED displays, plasma displays, touch screen displays, speakers, vibration modules, LEDs/other lights, and such like. System 1200 may also include or connect to devices which may act as both input and output devices, for example memory devices (hard drives, solid state drives, disk drives, compact flash cards, SD cards and the like) which system 1200 can read data from and/or write data to, and touch screen displays which can both display (output) data and receive touch signals (input).

System 1200 may also connect to one or more communications networks (e.g. the Internet, a local area network, a wide area network, a personal hotspot etc.) to communicate data to and receive data from networked devices, which may themselves be other computer processing systems.

System 1200 may be any suitable computer processing system such as, by way of non-limiting example, a server computer system, a desktop computer, a laptop computer, a netbook computer, a tablet computing device, a mobile/smart phone, a personal digital assistant, a personal media player, a set-top box, a games console. [note repetition in computer processing system description].

Typically, system 1200 will include at least user input and output devices 1214 and a communications interface 1216 for communication with a network such as network 106 of environment 100.

System 1200 stores or has access to computer applications (also referred to as software or programs)—i.e. computer readable instructions and data which, when executed by the processing unit 1202, configure system 1200 to receive, process, and output data. Instructions and data can be stored on non-transient machine readable medium accessible to system 1200. For example, instructions and data may be stored on non-transient memory 1210. Instructions and data may be transmitted to/received by system 1200 via a data signal in a transmission channel enabled (for example) by a wired or wireless network connection.

Applications accessible to system 1200 will typically include an operating system application such as Microsoft Windows®, Apple OSX, Apple IOS, Android, Unix, or Linux.

System 1200 also stores or has access to applications which, when executed by the processing unit 1202, configure system 1200 to perform various computer-implemented processing operations described herein. For example, and referring to the networked environment of FIG. 1 above, client system 104 includes a client application 112 which configures the client system 104 to perform the described client system operations. Similarly, server system 102 includes a data management application 108 which configures the server system 102 to perform the described server system operations.

In some cases part or all of a given computer-implemented method will be performed by system 1200 itself, while in other cases processing may be performed by other devices in data communication with system 1200 The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, work items, integers, steps, or elements.

The present disclosure uses terms “first,” “second,” etc. to describe various elements. Absent other context/requirements, however, these terms are used to distinguish different elements or features from one another and not in an ordinal sense. For example, absent other context/requirements use of first and second in respect of a first user interaction and a second user interaction does alone indicate any order or precedence: absent other context/requirements, the first user interaction could occur before or after the second user input. Furthermore, reference to a ‘first’ element or feature does not necessarily imply there must be a second element or feature (e.g. use of the word ‘first’ in ‘a first user input’ does not alone imply that there must be a second user input).

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. An item organisation system including:
one or more storage labels, each including a two-dimensional label region containing:
a storage attribute code including visible machine-readable indicia encoding data; and
a receptacle identifier, the receptacle identifier including a string of one or more human-readable alphanumeric characters, wherein the data encoded by the visible machine-readable indicia includes the receptacle identifier; and
a computer program including instructions, which when executed by one or more processors of an electronic device, cause the electronic device to capture an image of the storage attribute code and to decode the data encoded therein to generate decoded data.

2. An item organisation system according to claim 1, wherein the instructions further cause the electronic device to:
process the decoded data to obtain a storage image associated with a receptacle identified by the receptacle identifier; and
display the storage image on the electronic device.

3. An item organisation system according to claim 2, wherein processing the decoded data includes:
submitting the decoded data as a search query to an item storage database associated with the item organisation system; and
receiving the storage image at the electronic device as a search result of the search query.

4. An item organisation system according to claim 2, wherein the storage image depicts items stored in the receptacle.

5. An item organisation system according to claim 2, wherein the storage image is captured by a user of the item organisation system and stored in a user account maintained for the user in the item organisation system.

6. An item organisation system according to claim 2, wherein the instructions further cause the electronic device to render an augmented reality display on the electronic device, the augmented reality display including the storage image displayed on an incoming video feed capturing the storage attribute code.

7. An item organisation system according to claim 1, wherein the instructions further cause the electronic device to:
receive a storage search query at the electronic device;
process the storage search query to generate a search query result, the search query result including the or each receptacle identifier that identifies a receptacle storing an item referenced in the storage search query; and
display the search query result on the electronic device.

8. An item organisation system according to claim 1, wherein the instructions further cause the electronic device to:
retrieve from a data storage one or more storage images stored in the data storage for a user of the item organisation system;
display the one or more storage images on the electronic device;
receive at the electronic device a selection of at least one of the displayed storage images;
process the or each selected storage image to obtain a receptacle identifier list that includes the respective receptacle identifier associated with each selected storage image; and
display the receptacle identifier list on the electronic device.

9. An item organisation system according to claim 1, wherein the one or more storage attribute codes are digitally signed by an administrator of the item organisation system using a private encryption key.

10. An item organisation system according to claim 1, wherein the receptacle identifier is disposed amongst the visible machine-readable indicia.

11. A non-transitory computer-readable storage medium storing one or more programs, the one or more programs comprising instructions, which when executed by one or more processors of an electronic device, cause the electronic device to:
capture an image of a storage attribute code that includes visible machine-readable indicia encoding data; and
process the image to decode the data and generate decoded data,
wherein the storage attribute code is applied to a storage label with a two-dimensional label region that includes a receptacle identifier, the receptacle identifier including a string of one or more human readable alphanumeric characters, wherein the data encoded by the visible machine-readable indicia includes the receptacle identifier.

12. A medium according to claim 11, wherein the instructions further cause the electronic device to:
process the decoded data to obtain a storage image associated with a receptacle identified by the receptacle identifier; and
display the storage image on the electronic device.

13. A medium according to claim 12, wherein processing the decoded data includes:
submitting the decoded data as a search query to an item storage database associated with the electronic device; and
receiving the storage image at the electronic device as a search result of the search query.

14. A medium according to claim 12, wherein the storage image depicts items stored in the receptacle.

15. A medium according to claim 12, wherein the storage image is captured by a user of the electronic device and stored in a user account maintained for the user in the electronic device.

16. A medium according to claim 12, wherein the instructions further cause the electronic device to render an augmented reality display on the electronic device, the augmented reality display including the storage image displayed on an incoming video feed capturing the storage attribute code.

17. A medium according to claim 11, wherein the instructions further cause the electronic device to:
receive a storage search query at the electronic device;
process the storage search query to generate a search query result, the search query result including the or each receptacle identifier that identifies a receptacle storing an item referenced in the storage search query; and
display the search query result on the electronic device.

18. A medium according to claim 11, wherein the instructions further cause the electronic device to:
retrieve from a data storage one or more storage images stored in the data storage for a user of the electronic device;
display the one or more storage images on the electronic device;
receive at the electronic device a selection of at least one of the displayed storage images;
process the or each selected storage image to obtain a receptacle identifier list that includes the respective receptacle identifier associated with each selected storage image; and
display the receptacle identifier list on the electronic device.

19. A medium according to claim 11, wherein the one or more storage attribute codes are digitally signed by an administrator of the electronic device using a private encryption key.

20. A medium according to claim 11, wherein the receptacle identifier is disposed amongst the visible machine-readable indicia.

21. A storage label, including a two-dimensional label region containing:
a storage attribute code including visible machine-readable indicia encoding data; and
a receptacle identifier, the receptacle identifier including a string of one or more human-readable alphanumeric characters, wherein the data encoded by the visible machine-readable indicia includes the receptacle identifier, the storage label being operative for use in an item organisation system according to claim 1.
